(19) United States
(12) Patent Application Publication
(10) Pub. No.: US 2026/0279316 A1
(43) Pub. Date: Sep. 17, 2026

(54) HUMANIZING MUSIC SEQUENCE

(71) Applicant: Tampere University Foundation sr, Tampere (FI)

(72) Inventors: Esa RÄSÄNEN, Tampere (FI); Otto PULKKINEN, Tampere (FI)

(73) Assignee: Tampere University Foundation sr, Tampere (FI)

(21) Appl. No.: 19/566,073

(22) Filed: Mar. 13, 2026

(30) Foreign Application Priority Data
Mar. 14, 2025 (FI) 20255212

(51) Int. Cl. G10H 1/00

(52) U.S. Cl. CPC G10H 1/0025; G10H 2210/076; G10H 2210/105; G10H 2210/341; G10H 2210/391; G10H 2220/116

(57) ABSTRACT

There is provided improved accuracy for humanizing music sequences. A method for a digital audio workstation (DAW) comprises obtaining, by an digital audio workstation, sparse models of human-played music for humanizing a rhythmic structure of a music sequence (S), said sparse models comprising information indicating timing (t′₁, . . . , t′ₙ) of sounds (s₁, . . . , sₙ) of a humanized music sequence (S′), selecting, by the digital audio workstation, a model from the obtained sparse models based on at least one of the following: generating for each of the obtained sparse models a score; and selecting the model that has the highest score; or characterizing said obtained sparse models on a user interface of the digital audio workstation, and receiving user input on the user interface indicating the selected model; said method further comprising: adjusting, by the digital audio workstation, based on the selected model, timing information (tᵢ) of the rhythmic structure of the music sequence (S) to comprise an offset (oᵢ); and outputting, by the digital audio workstation, the music sequence (S) comprising one or more adjusted times (tᵢ+oᵢ).

### TECHNICAL FIELD

Various example embodiments relate to processing music sequences and more particularly to humanizing a rhythmic structure of a music sequence.

### BACKGROUND

Traditionally, music is recorded by musicians playing instruments simultaneously in a studio environment with the players performing in synchrony, whereby the interaction between musicians contribute to the groove and the feel of music. Alternatively, the tracks of a song can be recorded separately by syncing them using a click track, a pre-recorded metronome played through headphones to each musician in turn. In this case, each player brings their contribution to the feel of the song in such a way that the music is adjusted to match the time grid but may still have temporal variation.

Making a traditional studio recording requires expensive equipment, facilities and professional personnel. Recent advances in computer-based home recording techniques have provided means for even ‘bedroom’ producers to make music that comes very close to the sonic quality offered by professional studios. As a consequence, a large fraction of popular music is nowadays produced electronically using, for example, drum machines and algorithms for the drum tracks. As default, the music is generated on the grid, so that the tempo of the music dictating the drum beat and the other instruments is precisely quantized—in other words—that there are no fluctuations at all from the millisecond-precise beat.

Both the invention of click track and electronic music production significantly simplified music production, making it more cost-effective. Yet both inventions interfered with the way how the rhythmic variations that convey human feel are captured on recordings. It is widely known, and scientifically confirmed in several studies [1,2], that the variations inherent in human rhythms make music sound more natural and “human” compared to metronome-precise music. So far, no satisfactory solution has been suggested on how to add realistic human variations in music generated on the grid. The present solutions to tackle this problem are clearly insufficient as outlined below.

Implementing noise to temporal onsets of the instruments can be used to humanize music. The most common approach is to use randomized white noise in this process.

However, it is known that human rhythmic fluctuations do not follow white noise, but they have long-range correlations, i.e., the temporal fluctuations are not independent (as in white noise), but they have mutual dependencies. This corresponds to so-called pink noise or 1/f noise [3].

Pink noise has been recently used in humanization algorithms [4]. However, such an improvement from white noise is not yet sufficient to truly capture the human feel of playing. Especially drumming is characterized by temporal phrasing over the musical phrase, so that, for example, the snare drum is slightly “behind” from the notation. The phrasing applies to the duration of the musical phrase, that is, one or two bars (measures) of music, and then it is repeated in the following phrases. Any realistic humanization algorithms should capture this effect. However, so far, no universal yet adjustable model for this phrasing effect has been introduced.

In addition to—or instead of—using white and pink noise, it is possible to introduce or adjust swing or shuffle feel in rhythms. Swing phrasing is presented as a so-called triplet-feel by splitting, e.g., a quarter note into two-thirds and one-third (“full swing”) instead of half and half (“no swing”)—and this triplet feel can be adjusted by changing that ratio. Recent studies have shown that the triplet feel is present even in traditional rock music [5]. However, in practice such a model in digital music production is a simplistic and deficient approach to the concept of groove.

Finally, many Digital Audio Workstations (DAWs) have an option to generate so-called “groove templates”. However, their generation requires manual efforts and, in principle, every song requires a new template and manual fine-tuning.

In summary, the existing solutions can be split into the following three classes:
1. Adding white or pink noise (sound easily erratic, is hard to apply on multiple tracks, and
   does not convey the human groove)
2. Adjusting swing or shuffle (typically adjusts within a measure or a few, only an ad-hoc
   model of human groove)
3. Groove templates (requires effort: a template must be created for each new song)

### SUMMARY

The problem mentioned above is alleviated by providing a method and technical equipment, where the method is implemented. Various aspects comprise a method, a digital audio workstation, and a computer program product comprising a computer program stored therein, which are characterized by what is stated in the independent claims. Various example embodiments are disclosed in the dependent claims.

In a first aspect, the invention provides a method comprising
obtaining, by an digital audio workstation, sparse models of human-played music for humanizing a rhythmic structure of a music sequence (S), said sparse models comprising information indicating timing (t′₁, . . . , t′ₙ) of sounds (s₁, . . . , sₙ) of a humanized music sequence (S′);
selecting, by the digital audio workstation, a model from the obtained sparse models based on at least one of the following:
   generating for each of the obtained sparse models a score; and
   selecting the model that has the highest score; or
   characterizing said obtained sparse models on a user interface of the digital audio workstation, and receiving user input on the user interface indicating the selected model;
said method further comprising:
adjusting, by the digital audio workstation, based on the selected model, timing information (tᵢ) of the rhythmic structure of the music sequence (S) to comprise an offset (oᵢ); and
outputting, by the digital audio workstation, the music sequence (S) comprising one or more adjusted times (tᵢ+oᵢ).

In a second aspect, the invention provides a digital audio workstation comprising at least one processing core and memory comprising computer program code that when executed by the at least one processing core cause:
obtaining, by the digital audio workstation, sparse models of human-played music for humanizing a rhythmic structure of a music sequence (S), said sparse models comprising information indicating timing (t′₁, . . . , t′ₙ) of sounds (s₁, . . . , sₙ) of a humanized music sequence (S′);
selecting, by the digital audio workstation, a model from the obtained sparse models based on at least one of the following:
   generating for each of the obtained sparse models a score; and
   selecting the model that has the highest score; or
   characterizing said obtained sparse models on a user interface of the digital audio workstation, and receiving user input on the user interface indicating the selected model;
      and further cause:
adjusting, by the digital audio workstation, based on the selected model, timing information (tᵢ) of the rhythmic structure of the music sequence (S) to comprise an offset (oᵢ); and
   outputting, by the digital audio workstation, the music sequence (S) comprising one or more adjusted times (tᵢ+oᵢ).

In a third aspect, the invention provides a non-transitory computer-readable medium storing instructions that, when executed by at least one processor of a digital audio workstation, cause the digital audio workstation to perform the method according to the first aspect.

The features recited in the dependent claims and the embodiments in the description are mutually freely combinable unless otherwise explicitly stated. The exemplary embodiments presented in this text and their advantages relate by applicable parts to all aspects of the invention, even though this is not always separately mentioned.

An advantage of the present invention is that humanization of music sequences may be provided accurately.

### DESCRIPTION OF THE DRAWINGS

In the following, various example embodiments will be described in more detail with reference to the appended drawings, in which

FIG. 1 shows an example of a difference between a rhythmic structures of a human-played music sequence and a metronome signal;

FIG. 2 shows an example of timing deviations from a drum track;

FIG. 3 shows an example of a method in accordance with at least some embodiments of the invention;

FIG. 3 shows an example of a method in accordance with at least some embodiments of the invention;

FIG. 4 shows a block diagram of a device for humanizing music sequences according to an embodiment of the invention; and

FIG. 5 shows another block diagram of a device for humanizing music sequences according to another embodiment of the invention.

FIG. 6 and FIG. 7 show block diagrams of apparatuses for humanizing music sequences according to at least some embodiments.

### DESCRIPTION OF EXAMPLE EMBODIMENTS

The following embodiments are exemplary. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments.

Use of ordinal terms such as “first,” “second,” “third,” etc., in the claims and description to modify a described feature does not by itself connote any priority, precedence, or order of one described feature over another or the temporal order in which acts of a method are performed, but are used merely as labels to distinguish one described feature having a certain name from another described feature having a same name (but for use of the ordinal term) to distinguish the described feature.

As used herein, “at least one of the following:” and “at least one of” and similar wording, where the list of two or more elements are joined by “and” or “or”, mean at least any one of the elements, or at least any two or more of the elements, or at least all the elements.

### Music Sequence (S)

A music sequence (S) may be a computer readable data structure for a series of musical events or an audio track of music samples. The music sequence may define a series of sounds. Examples of the computer readable data structure for a series of musical events comprise a Musical Instrument Digital Interface (MIDI) file. Examples of the audio track of music samples comprise digital music formats for storing audio tracks such as MP3 and AAC. The music sequence may be computer generated, in particular by using software instruments or loops, or may be recorded natural music or a mix of both. The sounds may be recorded notes from an instrument, such as a drum, or may be metronome clicks or music samples e.g. from a software instrument, each sound occurring on a distinct time t, which may e.g. be the beginning of a music sample. When humanizing a music sequence comprising sounds, the time t may be an onset of a musical event such as a note or a beat. The onsets may be detected by a method in the prior art (cf. e.g. Bello et al., A Tutorial on Onset Detection In Music Signals, IEEE Transactions on Speech and Audio Processing, Vol. 13, No. 5, September 2005, fully incorporated by reference into the present application).

### Rhythmic Structure of Music Sequence

Rhythmic structure of a music sequence refers to patterns(s) of timing and duration of musical events of the musical events, e.g. notes and beats. These structures define the temporal organization of music.

### Human-Played Music

Human-played music, or natural music, has musical events that have a rhythmic structure. Timing of the musical events, for example IOIs, of sounds, include inaccuracies caused by human cognitive and motoric processes. The human-played music may be live music that is recorded and stored to an audio track for example, thereby forming a music sequence.

### Inter-Onset Intervals

Inter-onset intervals (IOIs) in the context of a music sequence (S) refer to the time intervals between the onsets of successive musical events, such as notes or beats. The onset of a note is the point in time when the note begins, typically marked by a sudden increase in amplitude or a transient. The IOI interval has a duration defined a time between a start (onset) of one note or beat and a start of the next note or beat. Inter-onset intervals (IOIs) can be used at least partially for defining the Rhythmic structure of a music sequence. Consider a simple drum pattern with a kick drum on the first beat and a snare drum on the second beat. If the kick drum occurs at 0 seconds and the snare drum occurs at 0.5 seconds, the IOI between the kick and snare is 0.5 seconds. If the next kick drum occurs at 1 second, the IOI between the snare and the next kick is also 0.5 seconds. This regular pattern of IOIs contributes to the steady rhythm of the drum pattern.

In an example, for the generalized periodic multi-limb timing model, an inter-onset interval _{Ti}(n) between a (n−1)-th and an n-th onset of instrument i is given by

$${T}_{i} ( n ) = {T}_{i} ( n ) - {T}_{i} ( n - 1 ) = {\sum }_{m =} \{ {J}_{i} ( n - 1 ) \} \hat{} \{ {J}_{i} ( n ) \} {C}_{0} ( m ) + {D}_{i} ( n ) - {D}_{i} ( n - 1 ) + {M}_{i} ( n ) - {M}_{i} ( n - 1 ) .$$

In this example, a covariance structure of the inter-onset intervals _{Ti}(n) of each instrument i is tridiagonal: diagonal elements comprise a contribution from the clock variance θ scaled by the number of clock intervals in the inter-onset interval, plus twice the combined limb variance ψᵢ, and lag−1 off-diagonal elements equal −ψᵢ, while higher-order autocovariances vanish.

In a first embodiment, the systematic phase-deviation processes Dᵢ(n) and the motor-noise processes Mᵢ(n) of distinct instruments are modeled as mutually independent, such that cross-instrument correlations in onset times arise solely through the shared latent internal clock process C₀(m). This independent-limb approximation simplifies estimation and is consistent with psychomotor literature on bimanual coordination.

In a further embodiment, the systematic phase-deviation processes of at least two distinct instruments are modeled as correlated according to a joint covariance structure. For example, phase deviations of a hi-hat and a snare drum may co-vary such that early deviations of the hi-hat tend to co-occur with early deviations of the snare relative to their respective mean phase offsets. In this embodiment, the digital audio workstation is configured to estimate cross-instrument covariance parameters characterizing the joint covariance structure from the human-played music data.

Digital Audio Workstation (DAW) is a computer executable software application or a standalone system for recording, editing, mixing, and producing music sequences(S).

### Examples of Typical Features of a DAW

1. Multitrack Recording: Allows users to record multiple audio tracks simultaneously, which can be individually edited and mixed.
2. Audio Editing: Provides tools for cutting, copying, pasting, and manipulating audio clips. Users can adjust the timing, pitch, and other properties of audio recordings.
3. MIDI Support: Enables the creation and editing of MIDI data, which can be used to control virtual instruments and hardware synthesizers.
4. Virtual Instruments: Includes software-based instruments that can emulate real-world instruments or create entirely new sounds.
5. Effects and Plugins: Supports various audio effects and plugins, such as reverb, delay, compression, and equalization, to enhance and shape the sound.
6. Mixing and Mastering: Offers a mixing console interface for adjusting levels, panning, and applying effects to individual tracks. Mastering tools help finalize the audio for distribution.
7. Automation: Allows users to automate changes in volume, panning, effects parameters, and other settings over time.
8. File Export: Provides options to export the final mix in various audio formats, such as WAV, MP3, and FLAC.

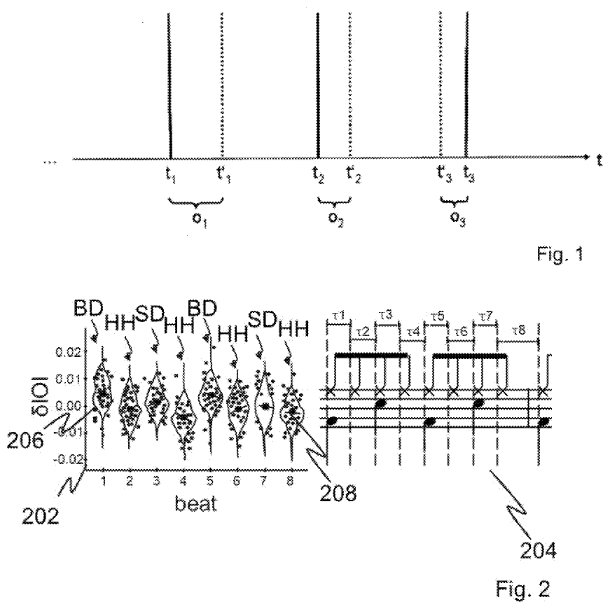

FIG. 1 shows an example of a difference between rhythmic structures of a human-played music sequence and a metronome signal. The difference between the rhythmic structures illustrates an effect of humanizing a music sequence to timing of sounds of the music sequence. The difference is considers a situation, where a human is playing an instrument by the rhythm of the metronome signal, and a human-played music sequence is produced that has musical events at a times t′₁, t′₂ and t′₃. Timing of sounds of the metronome signal is denoted by t₁, t₂ and t₃. A difference between the timings of the musical events of the human-played music sequence to associated timings of the metronome signal are denoted by o₁, o₂ and o₃.

The beats or clicks of the metronome occur on times t₁, t₂ and t₃ and constitute a regular sequence of the form

$${t}_{n} = {t}_{0} + nT , , \qquad ( 1 )$$

wherein tₙ is the temporal occurrence or time of the n^{th} beat, t₀ is the time of the initial beat and T denotes the time between metronome clicks.

The beats of the human-played music sequence occur on times t′₁, t′₂ and t′₃ and constitute an irregular sequence. The offsets oᵢ between the beats may be calculated as

$${o}_{n} = {t}_{n} - {t}_{n}^{′} . \qquad ( 2 )$$

It should be noted that, alternatively, the above definitions may also be generalized in order to track deviations of a sequence from a given metric pattern instead from a metronome. In other words, instead of taking regular distances T for the metronome clicks, a more complex metronome signal can be generated wherein distances between clicks are not equal but are distributed according to a more complex pattern. In particular, the pattern may correspond to a particular rhythm.

Compared to a real audio signal, the plot is stylized for the purpose of describing the present invention, which pertains to the temporal occurrence patterns of sounds. The skilled person will immediately recognize that in reality, each beat or note played is composed of an onset, an attack and a decay phase from which the present description abstracts. The human-played music sequence, or natural music sequence, may be for example a drum signal. The human-played music sequence may have timing deviations, which can be attributed to the cognitive and motor processes involved in human execution. These deviations are exemplified by the difference between the timings of the musical events of the human-played music sequence to associated timings of the metronome signal are denoted by o₁, o₂ and o₃. These deviations arise from the complex interplay between the brain's processing of musical information and the physical actions required to produce sound. Cognitive factors such as attention, memory, and perception, as well as motor skills like coordination and precision, all contribute to the natural variability in timing. The deviations T can be expressed by Wing-Kristofferson (WK) model [7, 8]

$${T}_{i} = {C}_{i} + {M}_{i} - {M}_{i} - 1 , \qquad ( 3 )$$

where Cᵢ are the time intervals generated by a cognitive clock, modeled as independent and identically distributed normal variates with mean μ (the intended interval length) and variance θ. Mᵢ are motor deviations in execution of those intervals similarly modeled as i.i.d normal variates with zero mean and variance φ[9].

A metronome is any device that produces a regulated audible and/or visual pulse, usually used to establish a steady beat, or tempo, measured in beats-per-minute (BPM) for the performance of musical compositions. Ideally, the pulses are equidistant. It should be noted that humans performing music will never exactly match the beat given by a metronome. In the illustrated example, the metronome serves for producing a time series of sounds that have a rhythmic structure for understanding the effect of humanization to a music sequence.

It should be noted that music performed by humans will always exhibit a certain amount of fluctuations compared with the steady beat of a metronome. Machine-generated music on the other hand, such as an artificial drum sequence, has no difficulty in always keeping the exact beat, as synthesizers and computers are equipped with ultra precise clocking mechanisms similar to the metronome. Therefore, machine-generated music, an artificial drum sequence in particular, is often recognizable just for this perfection and frequently devalued by audiences due to a perceived lack of human touch. The same holds true for music performed by humans which is recorded and then undergoes some kind of analogue or digital editing. Post-processing is a standard procedure in contemporary music production, e.g. for the purpose of enhancing human performed music having shortcomings due to a lack of performing skills or inadequate instruments, etc. Here also, even music originally performed by humans may acquire an undesired artificial touch.

FIG. 2 shows an example of timing deviations from a drum track. The timing deviations are illustrated by a plot 202 showing timing deviations of Inter-Onset-Intervals (IOIs) On (i) for each beat of the drum track, where i is the number of beats and n is the length of time series comprising the beats of the drum track. In the illustrated example the number of beats is eight (8) whereby in this example i==1, . . . , 8, and n=1, . . . , length of the time series/8. Staff 204 illustrates IOIs, τ, between the beats. The plot shows a mean deviation δIOI of IOIs for each beat. The δIOI is measured over the whole time series by calculating an average over i and n. The mean deviation δIOI at beat i (average over n only) may be positive or negative, indicating persistent variation around the notated IOIs shown on the staff 204. The IOIs are determined based on sounds from three instruments: a bass drum (BD), snare drum (SD) and hi-hat (HH). The bass drum is at beats 1 and 5, snare drum at beats 3 and 7, and hi-hat at beats 2, 4, 6 and 8. The IOIs are derived from music sequences of human-played music. In an example the music sequence may be from a single artist. The IOIs on the plot show violin plots of IOIs 206, which illustrate distributions of the timing deviations of the IOIs for each beat. For each beat a mean value 208 of the IOIs is identified by a solid circle inside the violin plot.

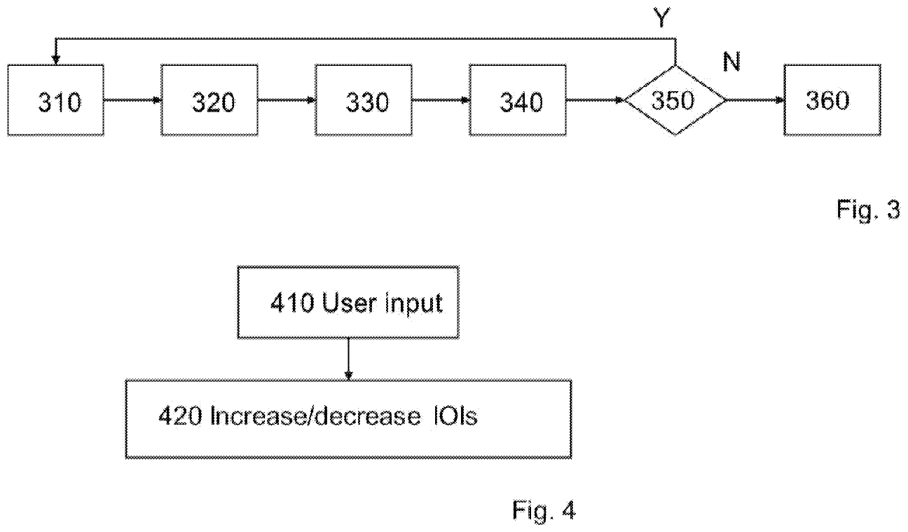

FIG. 3 shows an example of a method in accordance with at least some embodiments of the invention. The method provides humanizing a music sequence (S). The humanization is provided by adjusting timing of the rhythmic structure of the music sequence. The humanization of the method is described with reference to the rhythmic structure of a human-played music sequence and a metronome signal described with FIG. 1, where the metronome signal illustrates the rhythmic structure of the music sequence before humanization and the rhythmic structure of the human-played music illustrates the rhythmic structure after the humanization has been performed by adjusting the timing of the rhythmic structure of the music sequence. The humanization utilizes sparse models that may be generated by the method.

Phase 310 comprises obtaining, by an digital audio workstation, sparse models of human-played music for humanizing a rhythmic structure of a music sequence (S), said sparse models comprising information indicating timing (t′₁, . . . , t′ₙ) of sounds (s₁, sₙ) of a humanized music sequence (S′).

Phase 320 comprises selecting, by the digital audio workstation, a model from the obtained sparse models based on at least one of the following: generating for each of the obtained sparse models a score; and selecting the model that has the highest score; or characterizing said obtained sparse models on a user interface of the digital audio workstation, and receiving user input on the user interface indicating the selected model.

Phase 330 comprises adjusting, by the digital audio workstation, based on the selected model, at least a part of the times (tᵢ) of the music sequence (S) to comprise an offset (oᵢ).

Phase 340 comprises outputting, by the digital audio workstation, the music sequence (S) comprising one or more adjusted times (tᵢ+oᵢ).

In example in accordance with at least some embodiments, phase 310 comprises obtaining an audio track comprising human-played music; detecting onset timing (t₁, . . . ,tₙ) of the audio track; generating the sparse models based on the detected onset timing (t₁, . . . , tₙ). In this way the sparse models may be generated for humanizing music sequences. In an example, the sparse models may be generated based on deriving timing information of rhythmic structure of a plurality of music sequences of human-played, or natural, music and forming subsets of musical events of the rhythmic structure. Accordingly, each musical event may be assigned to at least one subset. The timing information of rhythmic structure may be derived for example by known methods using publicly available digital audio processing software, which provide a time series of digital audio data, for example Sonic Visualiser available from https://www.sonicvisualiser.org and Aubio available from https://aubio.org. The subsets of the musical events of the rhythmic structure may be formed based on assigning musical events associated with the same instrument to the same subset. In an example beats or notes played at the same time may be assigned to the same subset. On the other hand also musical events associated with different instruments may be assigned to the same subset provided the onsets of the musical events are related to each other. In an example, a sparse model for selection by a user may be generated based on natural music played by a single artist. On the other hand a sparse model for selection by a user may be generated based on natural music played by a plurality of artist that follow an instructed temporal phrasing.

In a further example, the sparse models of human-played music are not limited to models generated locally from user-provided recordings. The digital audio workstation may be provided with a library of pre-estimated sparse models representing various drumming styles, genres, or individual drummers. Such a library may be stored in memory of the apparatus, distributed with the DAW or plug-in, or made available for download. The user may select one of the pre-estimated sparse models via the user interface, and the selected model may be applied for humanizing music sequences without requiring access to original performance recordings.

In example in accordance with at least some embodiments, phase 310 comprises obtaining at least one computer readable data structure for a series of musical events, comprising timing information of the series of the musical events; and adjusting, based on the selected model, the timing information of the series of the musical events of the at least one computer readable data structure. In an example the computer readable data structure is a Musical Instrument Digital Interface (MIDI) file. In an example the timing information comprises information indicating onset timings of musical events for example information indicating Inter-Onset-Intervals of the musical events.

In an example in accordance with at least some embodiments, phase 310 comprises that each of the sparse models defines a partition structure for the timing (t′₁, . . . , t′ₙ) of sounds (s₁, . . . , sₙ) of the humanized music sequence (S′). The partition structure comprises subsets of musical events of the rhythmic structure. Accordingly, each musical event may be assigned to at least one subset. The subsets of the musical events of the rhythmic structure may be formed based on assigning musical events associated with the same instrument to the same subset. In an example beats or notes played at the same time may be assigned to the same subset. On the other hand also musical events associated with different instruments may be assigned to the same subset provided the onsets of the musical events are related to each other.

In an example in accordance with at least some embodiments, phase 310 comprises that the partition structure defines inter-onset-intervals of interrelated timings (t′₁, . . . , t′ₙ) of sounds (s₁, . . . , sₙ) of the humanized music sequence (S′). In an example, the partition structure comprises two or more, or a plurality of, parts. Each part of the partition structure of interrelated timings may be assigned an inter-onset-interval. In this way the inter-onset-intervals of each part may be adjusted based on characteristics of the interrelated timings. In an example, the inter-onset-interval is a random variable whose distribution is determined by characteristics of interrelated timings of human-played music sequence that has been used to generate the sparse model. Examples of the characteristics may include the mean and the variance of inter-onset intervals of each part. It should be noted that each part of the partition structure may be formed based on identifying interrelated timings. The interrelated timings may be for example onsets of the same instruments. However, it should be noted that the interrelated timings may be defined in principle such that correlation of interrelated timings between different parts is low, for example correlation of deviations of T between different parts is low.

In an example in accordance with at least some embodiments, phase 310 comprises that at least one of the sparse models comprises a generalized periodic multi-limb timing model of human-played music. The generalized periodic multi-limb timing model is configured to represent timing of a plurality of instruments (i=1, . . . , K), each instrument being associated with a respective limb of a multi-limb performance model, such as a drummer playing a drum kit with hands and feet. The generalized periodic multi-limb timing model comprises a latent internal clock process common to all instruments, and, for each instrument, a systematic phase-deviation process and a motor-noise process, as described in more detail below.

In an example in accordance with at least some embodiments, the sparse models further comprise information on velocity or dynamics of human-played music. Human drumming performance exhibits systematic and stochastic variation in the intensity of strikes, which is instrument-dependent and beat-class-dependent. For each instrument i and each beat class b, a velocity distribution may be constructed characterizing dynamics of human-played music for that instrument and beat class. In an example, the velocity distribution is modeled as a Gaussian distribution

$${V}_{i} ( n ) \sim N ( {η}_{i} ( b ) , {σ}_{i} ( b ) ) , \qquad ( 4 )$$

where ηᵢ(b) is a mean velocity of instrument i at beat class b and σᵢ(b) is a velocity variance. The parameters ηᵢ(b) and σᵢ(b) may be estimated from the human-played music data for each instrument and beat class. In a first embodiment, the velocity distributions of distinct instruments are estimated independently, such that the velocity of one instrument at a given beat class is statistically independent of the velocities of other instruments. In a further embodiment, the velocity distributions of at least two distinct instruments are modeled as correlated, and cross-instrument velocity covariance parameters are estimated. In use, the digital audio workstation may adjust velocity information of the music sequence (S) such that each velocity value νᵢ(n) of instrument i at onset n is modified to comprise a velocity offset derived from the velocity distribution of the corresponding instrument and beat class.

In an example, the latent internal clock process C₀(m) represents time intervals generated by an internal timekeeper and is common to all instruments of the multi-limb performance. For each instrument i, the systematic phase-deviation process Dᵢ(n) captures an instrument-specific, beat-class-dependent deviation from onset positions determined by the latent internal clock, and the motor-noise process Mᵢ(n) represents limb-specific execution noise of the corresponding limb. Parameters of the generalized periodic multi-limb timing model are estimated from data representing human-played music, for example from onset timing detected from an audio track or from a MIDI recording of a human drummer performing with multiple limbs. The sparse model thus obtained comprises information indicating timing of sounds of a humanized music sequence that is specific to a multi-limb performance.

In an example in accordance with at least some embodiments, the latent internal clock process C₀(m) of the generalized periodic multi-limb timing model is modeled as a sequence of independent Gaussian random variables with mean clock interval μ(m) and clock variance θ. The mean clock interval μ(m) may vary slowly over time to represent tempo fluctuations of the human-played music, while the clock variance θ>0 represents precision of the internal timekeeper. The latent internal clock process is common to all instruments of the multi-limb performance and provides a temporal scaffold on which instrument-specific deviations are superimposed.

In an example, the digital audio workstation is configured to select, as the model from the obtained sparse models, such a generalized periodic multi-limb timing model and to adjust timing information (tᵢ) of the rhythmic structure of the music sequence (S) to comprise offsets (oᵢ) derived from the systematic phase-deviation processes Dᵢ(n) and motor-noise processes Mᵢ(n) of the generalized periodic multi-limb timing model.

In an example, for each instrument i, the systematic phase-deviation process Dᵢ(n) is modeled as a Gaussian random variable

$${D}_{i} ( n ) \sim N ( {v}_{i} ( b ) , {ξ}_{i} ) , \qquad ( 5 )$$

where b=n mod p is a beat class determined by a period p of the rhythmic structure, νᵢ(b) is a beat-class-dependent mean phase offset of instrument i, and ξᵢ>0 is a phase-deviation variance for instrument i. The mean phase offsets νᵢ(b) encode a characteristic timing feel or groove of the human-played music, such as systematic delays or advances of particular instruments at certain beat positions within a rhythmic cycle.

In an example, for each instrument i, the motor-noise process Mᵢ(n) is modeled as a Gaussian random variable

$${M}_{i} ( n ) \sim N ( 0 , {φ}_{i} ) , \qquad ( 6 )$$

where φᵢ>0 is a motor variance for instrument i. The motor-noise process has zero mean, representing unbiased limb-specific execution noise, and its variance may differ between instruments due to differences in limb precision or biomechanical demands. Since the systematic phase-deviation process Dᵢ(n) and the motor-noise process Mᵢ(n) appear as a sum in onset times and inter-onset intervals, their variances are additive and only a combined limb variance ψᵢ=φᵢ+ξᵢ can be reliably estimated from onset timing data, whereas φᵢ and ξᵢ are not separately identifiable.

In an example, phase 320 comprises calculating the score for each of the sparse models. The models may be evaluated based on their score and the model that has the highest score may be selected for humanizing the music sequence.

In an example in accordance with at least some embodiments, phase 320 comprises that the score is determined based on a cognitive bias and a motoric bias of the model to the timing (t′₁, . . . , t′ₙ) of sounds (s₁, . . . , sₙ) of the humanized music sequence (S′).

In this way the natural variability of timing may be accounted for in the selection of the model. In an example the timing of sounds is IOIs.

In an example in accordance with at least some embodiments, phase 320 comprises that the score is determined based on:
a match of a sparse model to a period of the human-played music; and
a cost of a period length of the human-played music; and
a cost of a number of parts of the partition structure of the period of the human-played music; and
a cost of entropy of the partition structure. In an example the score may be determined based on a periodic Bayesian Information Criterion (pBIC). The sparse model that maximizes the pBIC may be selected for humanizing the music sequence.

In an example in accordance with at least some embodiments, phase 320 comprises, the score is determined based on a periodic Bayesian Information Criterion (pBIC). In an example, the pBIC may be selected for humanizing the music sequence. The pBIC is an extension of the Bayesian Information Criterion (BIC) and provides determining scores for selecting sparse models. Determining the score based on pBIC provides simultaneous maximization of the likelihood function L of a stochastic, periodic model of rhythm production, and minimization of cost terms based on the period and complexity of the partition structure. The pBIC provides determining the score based on:
a match of a sparse model to a period of the human-played music; and
a cost of a period length of the human-played music; and
a cost of a number of parts of the partition structure of the period of the human-played music; and
a cost of entropy of the partition structure. Accordingly, the cost terms in pBIC include, cost for period length p, cost for number of parts, n, in partition of each period, and entropy (log-norm), log∥π∥, of the partition. In an example, an extension of Wing-Kristoffersson model to contain periodic variation of the expected cognitive component μ is used to model the time-series, and its likelihood function enters the computation of pBIC.

The Bayesian Information Criterion (pBIC) may be expressed by:

$$pBIC = - 2 ℒ ( {( {μ}_{π ( i )} )}_{i = 1}^{n} , Θ \vert τ ) - 2 {a}_{1} log f ( p , n ) + {a}_{2} k log T + {a}_{3} nm log \frac{T}{p} + {a}_{4} m log ‖ π ‖ , \qquad ( 7 )$$

in which T is the total length of the time series, p is the period of the model, and n is the number of parts in the partition π. m is the number of parameters characteristic to each part of the partition π. In the log-likelihood function [symbol] ,

$${( {μ}_{π ( i )} )}_{i = 1}^{n}$$

is the sequence of parameters characteristic to each part of the partition π, and Θ represents all other parameters common to all parts and all beats. The function ƒ is a prior distribution for the period p and the number of parts n. k is the number parameters common to all parts and all beats. ∥π|=Π∥ᵢ| is the norm of the partition, where |πᵢ|, i=1, . . . , n, are the part sizes. The parameters a₁, a₂, a₃ and a₄ may be adjusted to increase or decrease the importance of each term in model selection.

The first term of the pBIC is log-likelihood term that is maximized for a period of human-played music. The second term of the pBIC represents cost of possible models that match period of human-played music. The third term of the pBIC represents common parameters for the human played music. The fourth term of the pBIC represents cost for number of the partition structure. The fifth term of the pBIC represents cost of entropy of the IOIs.

In an example in accordance with at least some embodiments, the log-likelihood function used in determining the score of a sparse model is constructed by combining inter-onset interval (IOI) residual components and phase residual components, which are conditionally Gaussian given latent clock increments. However, the joint covariance matrix that couples IOI and phase deviations across limbs and time through the latent internal clock process may be computationally demanding to invert. To address this, a decoupling approximation may be applied that factorizes the joint likelihood into independent components for IOI residuals and phase residuals across the plurality of instruments. In this approximation, cross-covariances between IOI and phase components are neglected and IOI and phase are treated as marginally independent processes. The resulting log-likelihood simplifies to a sum of limb-wise Gaussian log-likelihoods, each limb-wise log-likelihood being computed from IOI and phase residuals of a respective instrument. This enables efficient parameter estimation while preserving interpretability of the model parameters as clock variance, limb-specific variability and beat-class-dependent timing feel.

In an example, phase 320 comprises that the sparse models are provided on a user interface of the digital audio workstation (DAW) for selection by a user of the DAW. The user input of the user is used to determine which of the sparse models is selected for humanizing the music sequence. In an example the user interface may provide, e.g. by displaying to the user, information that characterizes each model. Examples of the information that characterizes each model comprise a name of an artist and a temporal phrasing provided by the model. In an example, a sparse model for selection by a user may be generated based on natural music played by a single artist. On the other hand, a sparse model for selection by a user may be generated based on natural music played by a plurality of artist that follow an instructed temporal phrasing.

In an example, phase 330 comprises that timing (tᵢ) of musical events, or the rhythmic structure, of the music sequence (S) is adjusted based on the information indicating timing of sounds provided by the selected sparse model by adding an offset (oᵢ) to the timing (tᵢ) of musical events of the music sequence. The offset may be a positive value or negative value, whereby timing of musical events for the humanized music sequence is obtained by tᵢ+oᵢ. It should be noted that adjusting at least a part of the timings of the musical events may be sufficient for humanizing the music sequence. However, for accurately following the temporal phrasing of the selected sparse model, adjusting all the musical events of the rhythmic structure may be preferred.

In an example in accordance with at least some embodiments, when the selected sparse model is a generalized periodic multi-limb timing model, the digital audio workstation computes, for each instrument i and onset index n, a modeled onset time Tᵢ(n) according to

$${T}_{i} ( n ) = {\sum }_{m = 1} \hat{} \{ {J}_{i} ( n ) \} {C}_{0} ( m ) + {D}_{i} ( n ) + {M}_{i} ( n ) , \qquad ( 8 )$$

where Jᵢ(n) denotes an index of the latent internal clock at the n-th occurrence of instrument i. A timing offset oᵢ(n) for adjusting the timing (tᵢ) of the music sequence (S) may then be determined based on a difference between the modeled onset time Tᵢ(n) and a quantized onset time of the music sequence (S), and the adjusted time tᵢ+oᵢ is obtained by adding the timing offset to the quantized onset time.

In an example, phase 330 comprises generating, at the DAW, a tempo curve based on the selected model and adjusting, at the DAW, timing of tracks to match tempo changes indicated by the tempo curve. In this way the DAW may generate a music sequence that comprises a plurality of audio tracks that are humanized in accordance to the selected sparse model. In an example, warping or time-stretching features of the DAW may be used for synchronizing the tracks with the tempo curve.

In an example in accordance with at least some embodiments, phase 340 comprises that the music sequence (S) is stored to a memory or fed to a playback component. In an example the playback component may be at the DAW or at another device. In an example, the playback component is configured for playback of one or more computer readable data structures for musical events such, for example a MIDI synthesizer for playback of MIDI files. In another example, the payback component is configured for playback of an audio track. The playback component may be connected to a digital or analogue audio output. External audio equipment such as speakers headphones or amplifiers may be connected to the audio output. It should be noted that also the music sequence stored to the memory may be provided to the playback component after being stored in the memory.

The method ends in phase 360 after the music sequence has been humanized. In an example in accordance with at least some embodiments, an optional phase 350 comprises determining whether a further music sequence should be humanized and if at least one further music sequence is to be humanized, the method may proceed to phase 310. Otherwise the method may end in phase 360.

FIG. 4 shows an example of a method for controlling a rate of humanizing a music sequence in accordance with at least some embodiments of the invention. The method may be performed in connection with phase 340 described with FIG. 3. Phase 410 comprises receiving user input indicating a rate for adjusting the at least a part of the times (tᵢ) of the music sequence (S) to comprise an offset (oᵢ). Phase 420 comprises controlling said adjusting at least a part of the times (tᵢ) of the music sequence (S) to comprise an offset (oᵢ), based on the indicated rate. In this way the rate of humanization of the music sequence may be controlled by the user. In an example, the rate of humanization may be set to a low rate, a medium rate or a high rate. At a medium rate of humanization, the offset (oᵢ) for adjusting the times (tᵢ) of the music sequence (S) may be determined in principle by the selected model. However, at a low rate of humanization, an actual offset (oᵢ) for adjusting the times (tᵢ) of the music sequence (S) may be less than the offset (oᵢ) determined by the selected model. On the other hand, at a high rate of humanization, an actual offset (oᵢ) for adjusting the times (tᵢ) of the music sequence (S) may be higher than the offset (oᵢ) determined by the selected model. The high rate of humanization and low rate of humanization may implemented by a correction factor that is adjusted based on the user input and applied to the offset (oᵢ) determined by the selected model.

In an example in accordance with at least some embodiments, the rate for adjusting the times (tᵢ) of the music sequence (S) to comprise an offset (oᵢ) is represented by a humanization rate parameter α∈ [symbol] . The digital audio workstation may scale the timing offsets oᵢ(n) and, when velocity humanization is applied, velocity offsets for each instrument i and onset n by the humanization rate α, such that adjusted onset times and velocities are given by

$${t}_{i}^{′} ( n ) = {t}_{i} ( n ) + α \cdot {o}_{i} ( n ) and {v}_{i}^{′} ( n ) = {v}_{i} ( n ) + α \cdot δ {v}_{i} ( n ) . \qquad ( 9 )$$

The humanization rate α admits the following interpretations: when α=0, the music sequence is output without humanization; when 0<α≤1, the music sequence is output with partial to full humanization; when α>1, the humanization is exaggerated beyond the estimated human performance characteristics; and when α<0, an inverse humanization is applied, wherein timing and velocity offsets are applied in a direction opposite to the estimated human performance characteristics.

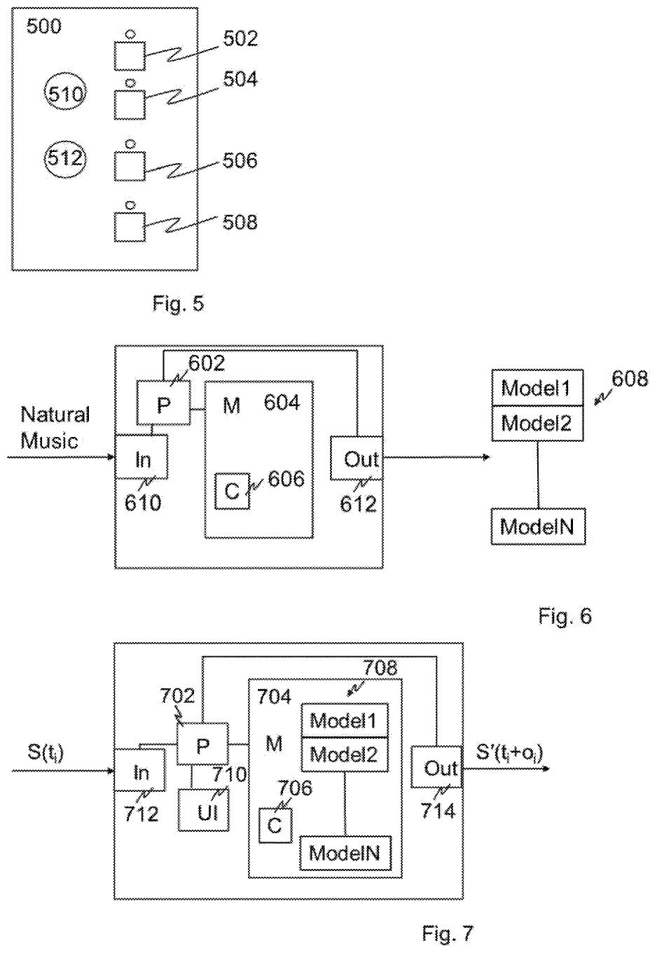

FIG. 5 illustrates an example of a user interface for a digital audio workstation in accordance with at least some embodiments. The user interface 500 characterizes one or more sparse models of human-played music for humanizing a rhythmic structure of a music sequence (S). In an example, the user interface comprises user interface elements corresponding to sparse models 502, 504, 506, 508. The user interface elements may be configured to be selected by a user based on user input to the user interface elements. When a user interface element is selected a sparse model corresponding to the user interface element is selected and may be applied for humanizing music sequences in accordance to described with the method described with FIG. 3. It should be note that each of the user interface elements may be configured to indicate whether the user interface element is selected or not. In an example, each of the user interface elements may be configured to change their appearance, in response to a selection of the user interface element by the user. In an example, a user interface element may be a graphical element displayed on a display device, whereby its shape and/or color may be changed in response to the selection of the user. On the other hand, each of the user interface elements may be associated with an indicator that may be configured to change its appearance, in response to a selection of the user interface element by the user. In an example, the indicator may be a graphical element displayed on a display device or an indicator light source. The shape and/or color of the graphical element displayed on a display device may be changed in response to the selection of the user. The light source may be switched on in response to the selection of the user.

In an example in accordance with at least some embodiments, the user interface is configured to present a characterization of one or more sparse models. The characterization may comprise visual representations of model parameters, such as mean phase offsets vᵢ(b) per instrument and beat class (for example as a grid or polar plot showing timing deviations within a rhythmic cycle), combined limb variances ψᵢ (for example as bar charts or numerical displays), clock variance θ, and, when velocity humanization is applied, velocity distribution parameters per instrument and beat class.

The user may inspect these visualizations to understand the timing and dynamic characteristics of each model and select a desired model or combination of models via the user interface.

In an example, the digital audio workstation is configured to perform style interpolation between distinct sparse models. Let Θ₁ denote a set of parameters of a first sparse model representing a first humanization style, and Θ₂ denote a set of parameters of a second sparse model representing a second humanization style. A style interpolation parameter β∈ [symbol] may be received as user input, and an interpolated set of parameters may be computed as

$${Θ}_{β} = ( 1 - β ) {Θ}_{1} + {βΘ}_{2} . \qquad ( 10 )$$

When β=0, the interpolated model equals the first model; when β=1, it equals the second model. Values of β between 0 and 1 produce intermediate styles that blend characteristics of both models, and values of β outside the interval [0, 1] produce extrapolated styles that extend stylistic differences between the two models beyond their observed range. The digital audio workstation may adjust timing and, when velocity humanization is applied, velocity information of the music sequence (S) based on the interpolated set of parameters.

In an example in accordance with at least some embodiments, the digital audio workstation supports track parameter automation for the humanization rate α and the style interpolation parameter β. The DAW may provide one or more automation lanes encoding time-varying values of α and/or β as floating-point numbers mapped to respective time positions within the music sequence. During playback, the DAW may evaluate the automation curves at each onset time, or at a higher temporal resolution, and apply the current values of α and β to compute timing and velocity offsets for each instrument at each onset. In this way, the extent and style of humanization may vary over the course of playback according to the track parameter automation, enabling musically expressive effects such as gradually increasing humanization, crossfading between drumming styles, or applying inverse humanization before a transition.

In an example in accordance with at least some embodiments, the user interface comprises one or more control elements 510, 512 for controlling use of the selected sparse model for humanizing music sequences. Each of the control elements may provide receiving user input indicating a rate for adjusting the at least a part of the times (tᵢ) of the music sequence (S) to comprise an offset (oᵢ) for performing phase 410 described with FIG. 4. In this way adjusting at least a part of the times (tᵢ) of the music sequence (S) to comprise an offset (oᵢ), based on the indicated rate may be performed in accordance with phase 420 described with FIG. 4. Examples of the user interface elements may be configured to be selected by a user based on user input to the user interface elements. Examples of the user interface elements comprise control knobs and control slides that may be movable by the user to more than one position for indicating the rate.

FIG. 6 and FIG. 7 show block diagrams of apparatuses for humanizing music sequences according to at least some embodiments. The apparatuses may be DAWs. The apparatuses comprise at least one processor 602, 702 and memory 604, 704 comprising computer program code 606, 706 that when executed by the at least one processor cause execution of one or more functionalities in accordance with at least some embodiments.

Referring to FIG. 6 the apparatus 600, is configured for generating sparse models 608 for humanizing music sequences. The sparse models may be generated based on music sequences S(tᵢ) that are received as input to the apparatus. The music sequences received as input to the apparatus may be human-played music, or natural music. The generated sparse models may be stored to the memory 604 of the apparatus or transferred over a data bus or a data transfer connection to another apparatus or a software component.

It should be noted that the apparatus 600 may comprise an audio input interface 610 for receiving music sequences and an output interface 612 for output of the generated models to the memory of the apparatus or to another apparatus. The processor may be operatively connected to the memory, audio input interface and output interface for causing execution of one or more functionalities in accordance with at least some embodiments

Referring to FIG. 7 the apparatus 700, is configured for humanizing one or more music sequences S(tᵢ) based on a selected sparse model. The music sequences carry timing information of rhythmic structure. The timing information carried by the music sequence may be derived from the music sequence for example by known methods using commercially available digital audio processing software, which provide a time series of digital audio data. The apparatus may be provided with one or more sparse models 708 for humanizing the one or more music sequences. The sparse model for humanizing the one or more music sequences may be selected from the sparse models stored in the memory 704. The music sequence may be humanized based on the selected sparse model as described with the method of FIG. 3 and FIG. 4. The apparatus 700 may further comprise a user interface 710 via which user input may be obtained and/or information, such as information that characterized the sparse models stored at the memory and information indicating selected sparse model, may be communicated to the user. The apparatus may output a humanized music sequence S′(tᵢ+oᵢ), where the timing of the rhythmic structure of the music sequence S(tᵢ) has been adjusted based the selected sparse model.

It should be noted that the apparatus 700 may comprise an input interface 712 for receiving music sequences to be humanized and an output interface 714 for output of humanized music sequences to the memory of the apparatus, or to another apparatus or a software component, for example a playback component. The processor may be operatively connected to the memory, input interface and output interface for causing execution of one or more functionalities in accordance with at least some embodiments.

In an example in accordance with at least some embodiments, there is provided a computer program comprising computer program code configured to, when executed on at least one processor of a digital audio workstation, cause the digital audio workstation to perform one or more functionalities of in accordance with at last some embodiments. In an example the computer program is a software component, such as a plug-in, for a Digital Audio Workstation (DAW). The computer program enables the DAW to perform humanization of music sequences in accordance to described with the method of FIG. 3. Example format for the plug-in comprise VST, AU, and AAX.

In an example in accordance with at least some embodiments, the decoupling approximation and limb-wise factorization of the log-likelihood enable parameter estimation that is suitable for real-time or near-real-time operation on commodity hardware. The limb-wise factorization reduces the dimensionality of the optimization problem from a full joint parameter space to a set of smaller, independent sub-problems. Furthermore, the computational cost of applying humanization, i.e. computing and adding timing and velocity offsets to the music sequence (S), is negligible compared to the cost of audio rendering, such that the humanization process does not introduce perceptible latency during real-time playback.

Embodiments may be implemented in software, hardware, application logic or a combination of software, hardware and application logic. The software, application logic and/or hardware may reside on memory, or any computer media. In an example embodiment, the application logic, software or an instruction set is maintained on any one of various conventional computer-readable media. In the context of this document, a “memory” or “computer-readable medium” may be any media or means that can contain, store, communicate, propagate or transport the instructions for use by or in connection with an instruction execution system, apparatus, or device, such as a computer.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

### REFERENCES

[1] Hennig H, Fleischmann R, Fredebohm A, Hagmayer Y, Nagler J, Witt A, et al. (2011) The Nature and Perception of Fluctuations in Human Musical Rhythms. PLOS ONE 6 (10): e26457. https://doi.org/10.1371/journal.pone.0026457; Holger Hennig, Ragnar Fleischmann, Theo Geisel, Physics Today 65 (7), 64-65 (2012); https://doi.org/10.1063/PT.3.1650
[2] Räsänen E, Pulkkinen O, Virtanen T, Zollner M, Hennig H (2015) Fluctuations of Hi-Hat Timing and Dynamics in a Virtuoso Drum Track of a Popular Music Recording. PLOS ONE 10 (6): e0127902. https://doi.org/10.1371/journal.pone.0127902
[3] Ary L. Goldberger, Luis A. N. Amaral, Jeffrey M. Hausdorff, and H. Eugene Stanley, Fractal dynamics in physiology: Alterations with disease and aging, Proc Natl Acad Sci 2466-72 (2002); https://doi.org/10.1073/pnas.012579499
[4] Hennig H, Fleischmann R, Theis F J, Geisel T (2010) Method and device for humanizing musical sequences. U.S. Pat. No. 7,777,123.
[5] Kristian Walhström, Student-Centered Musical Expertise in Popular Music Pedagogy and Hard Rock Groove—a Design-Based and Psychodynamic Approach, PhD Thesis, University of Helsinki 2022; http://urn.fi/URN: ISBN: 978-951-51-8048-3
[6] O. Pulkkinen and E. Räsänen, Periodic Time-Series Model Captures the Human Feel of Drumming (in preparation, 2024)
[7] Alan M. Wing and A. B. Kristofferson. Response delays and the timing of discrete motor responses. Perception & Psychophysics, 14 (1): 5-12, February 1973. ISSN 1532-5962. URL https://doi.org/10.3758/BF03198607.
[8] Dirk Vorberg and Alan Wing. Chapter 4 modeling variability and dependence in timing. In Herbert Heuer and Steven W. Keele, editors, Motor skills, volume 2 of Handbook of Perception and Action, pages 181-262. Academic Press, 1996 . . . . URL https://www.sciencedirect.com/science/article/pii/s1874582206800071.
[9] Jarl K. Kampen and Tom A. B. snijders. Estimation of the wing-kristofferson model for discrete motor responses. British Journal of Mathematical and Statistical Psychology, 55 (1): 159-168, May 2002. URL https://doi.org/10.1348/000711002159626.

Reference signs to the drawings

| t₁, t₂ and t₃ | Timing of sounds of the metronome signal in FIG. 1 |
|---|---|
| t′₁, t′₂ and t′₃ | Timing of musical events of human-played |
| | music sequence in FIG. 1 |
| o₁, o₂ and o₃ | Difference between the timings of the musical |
| | events of the human-played music sequence to |
| | associated timings of the metronome signal |
| | in FIG. 1 |
| δₙ (δ₁, . . . , δ₈) | Deviations of Inter-Onset-Intervals (IOIs) |
| | for beats in FIG. 2 |
| τ | IOIs in FIG. 2 |
| BD | Bass drum beat in FIG. 2 |
| SD | Snare drum beat in FIG. 2 |
| HH | Hi-hat beat in FIG. 2 |
| 202 | Plot showing timing deviations of IOIs in FIG. 2 |
| 204 | Staff illustrating IOIs between beats in FIG. 2 |
| 206 | Violin plots of IOIs 206 in FIG. 2 |
| 208 | Mean value of IOIs in FIG. 2 |
| 310, 320, 330, | Phases of FIG. 3 |
| 340, 350, 360 | |
| 410, 420 | Phases of FIG. 4 |
| 500 | User interface in FIG. 5 |
| 502, 504, 506, 508 | Sparse models of user interface in FIG. 5 |
| 510, 512 | Control elements of user interface in FIG. 5 |
| 602 | Processor in FIG. 6 |
| 604 | Memory in FIG. 6 |
| 606 | Computer program code in FIG. 6 |
| 608 | Sparse models in FIG. 6 |
| 610 | Audio input interface FIG. 6 |
| 612 | Output interface FIG. 6 |
| 702 | Processor in FIG. 7 |
| 704 | Memory in FIG. 7 |
| 706 | Computer program code FIG. 7 |
| 708 | Sparse models in FIG. 7 |
| 710 | User interface in FIG. 7 |
| 712 | Input interface in FIG. 7 |
| 714 | Output interface FIG. 7 |

What is claimed is:

1. Method for a digital audio workstation (DAW), comprising:
obtaining, by a digital audio workstation, sparse models of human-played music for humanizing a rhythmic structure of a music sequence (S), said sparse models comprising information indicating timing (t′₁, . . . , t′ₙ) of sounds (s₁, . . . , sₙ) of a humanized music sequence (S′);
selecting, by the digital audio workstation, a model from the obtained sparse models based on at least one of the following:
generating for each of the obtained sparse models a score; and selecting the model that has the highest score; or
characterizing said obtained sparse models on a user interface of the digital audio workstation, and receiving user input on the user interface indicating the selected model;
said method further comprising:
adjusting, by the digital audio workstation, based on the selected model, timing information (tᵢ) of the rhythmic structure of the music sequence (S) to comprise an offset (oᵢ); and
outputting, by the digital audio workstation, the music sequence (S) comprising one or more adjusted times (tᵢ+oᵢ).

2. The method of claim 1, comprising:
obtaining, by the digital audio workstation, an audio track comprising human-played music;
detecting, by the digital audio workstation, onset timing (t₁, . . . , tₙ) of the audio track;
generating, by the digital audio workstation, the sparse models based on the detected onset timing (t₁, . . . , tₙ).

3. The method of claim 1, comprising:
obtaining, by the digital audio workstation, at least one computer readable data structure for a series of musical events, comprising timing information of the series of the musical events; and
adjusting, by the digital audio workstation, based on the selected model, the timing information of the series of the musical events of the at least one computer readable data structure.

4. The method of claim 1, comprising:
generating, at the digital audio workstation, a tempo curve based on the selected model and adjusting, at the digital audio workstation, timing of tracks to match tempo changes indicated by the tempo curve.

5. The method of claim 1, wherein each of the sparse models defines a partition structure for the timing (t′₁, . . . , t′ₙ) of sounds (s₁, . . . ,sₙ) of the humanized music sequence (S′).

6. The method of claim 5, wherein the partition structure defines inter-onset intervals (IOIs) of interrelated timings (t′₁, . . . , t′ₙ) of sounds (s₁, . . . , sₙ) of the humanized music sequence (S′).

7. The method of claim 1, wherein the score is determined based on a cognitive bias and a motoric bias to the timing (t′₁, . . . , t′ₙ) of sounds (s₁, . . . , sₙ) of the humanized music sequence (S′).

8. The method of claim 1, wherein the score is determined based on a periodic Bayesian Information Criterion (pBIC).

9. The method of claim 1, wherein the score is determined based on:
a match of a sparse model to a period of the human-played music;
a cost of a period length of the human-played music;
a cost of a number of parts of the partition structure of the period of the human-played music;
a cost of entropy of the partition structure.

10. The method of claim 1, wherein the music sequence (S) is stored to a memory or fed to a playback component.

11. The method of claim 1, comprising:
receiving user input indicating a rate for adjusting the at least a part of the times (tᵢ) of the music sequence (S) to comprise an offset (oᵢ); and
controlling said adjusting at least a part of the times (tᵢ) of the music sequence (S) to comprise an offset (oᵢ), based on the indicated rate.

12. The method of claim 1,
wherein the selected sparse model comprises a generalized periodic multi-limb timing model for a plurality of instruments (i=1, . . . , K), each instrument being associated with a respective limb of a multi-limb performance model, the generalized periodic multi-limb timing model comprising:
a latent internal clock process C₀(m), common to all instruments, representing clock-interval variability of an internal timekeeper;
for each instrument i, a systematic phase-deviation process Dᵢ(n) having a beat-class-dependent mean phase offset νᵢ(b), where b=n mod p is a beat class determined by a period p of the rhythmic structure; and
for each instrument i, a motor-noise process Mᵢ(n) representing limb-specific execution noise;
wherein parameters of the generalized periodic multi-limb timing model are estimated, by the digital audio workstation, from data representing human-played music, and wherein the offset (oᵢ) used in adjusting the timing information (tᵢ) of the music sequence (S) is derived from the systematic phase-deviation process Dᵢ(n) and the motor-noise process Mᵢ(n) of the generalized periodic multi-limb timing model.

13. The method of claim 12,
wherein the latent internal clock process C₀(m) is modeled as a sequence of independent Gaussian random variables with mean clock interval μ(m) and clock variance θ, and wherein the mean clock interval μ(m) is allowed to vary over time to represent tempo fluctuations of the human-played music.

14. The method of claim 12,
wherein, for each instrument i, the systematic phase-deviation process Dᵢ(n) is modeled as a Gaussian random variable Dᵢ(n)~N(νᵢ(b), ξᵢ) with beat-class-dependent mean phase offset νᵢ(b) and phase-deviation variance ξᵢ, and wherein the beat-class-dependent mean phase offsets νᵢ(b) encode an instrument-specific timing feel of the human-played music.

15. The method of any of claim 12,
wherein, for each instrument i, the motor-noise process Mᵢ(n) is modeled as a Gaussian random variable Mᵢ(n)~N(0, φᵢ) with zero mean and motor variance φᵢ, and wherein a combined limb variance νᵢ=φᵢ+ξᵢ is estimated as a single parameter for each instrument i from onset timing data of the human-played music.

16. The method of claim 12,
wherein an onset time Tᵢ(n) of instrument i in the generalized periodic multi-limb timing model is computed, by the digital audio workstation, according to
$${T}_{i} ( n ) = {\sum }_{m = 1} \hat{} \{ {J}_{i} ( n ) \} {C}_{0} ( m ) + {D}_{i} ( n ) + {M}_{i} ( n ) ,$$
where Jᵢ(n) denotes an index of the internal clock at the n-th occurrence of instrument i, and wherein the offset (oi) applied to the timing information (ti) of the music sequence (S) is based on a difference between the computed onset time Tᵢ(n) and a quantized onset time of the music sequence (S).

17. The method of claim 12,
wherein an inter-onset interval τᵢ(n) between a (n−1)-th and an n-th onset of instrument i in the generalized periodic multi-limb timing model is given by
$${τ}_{i} ( n ) = {T}_{i} ( n ) - {T}_{i} ( n - 1 ) = {\sum }_{m} \{ {J}_{i} ( n - 1 ) \} \hat{} \{ {J}_{i} ( n ) \} {C}_{o} ( m ) + {D}_{i} ( n ) - {D}_{i} ( n - 1 ) + {M}_{i} ( n ) - {M}_{i} ( n - 1 ) ,$$
and wherein a covariance structure of the inter-onset intervals τᵢ(n) of each instrument i is tridiagonal with diagonal elements comprising a contribution from the clock variance θ and twice the combined limb variance ψᵢ, and with lag−1 off-diagonal elements equal to −ψᵢ.

18. The method of claim 12,
wherein, in a first embodiment, the systematic phase-deviation processes Dᵢ(n) and the motor-noise processes Mᵢ(n) of distinct instruments are modeled as mutually independent so that cross-instrument correlations in onset times arise solely through the shared latent internal clock process C₀(m), and wherein, in a further embodiment, the systematic phase-deviation processes of at least two distinct instruments are modeled as correlated according to a joint covariance structure estimated from the human-played music.

19. A digital audio workstation comprising at least one processing core and memory comprising computer program code that when executed by the at least one processing core cause:
obtaining, by the digital audio workstation, sparse models of human-played music for humanizing a rhythmic structure of a music sequence (S), said sparse models comprising information indicating timing (t′₁, . . . , t′ₙ) of sounds (s₁, . . . , sₙ) of a humanized music sequence (S′);
selecting, by the digital audio workstation, a model from the obtained sparse models based on at least one of the following:
generating for each of the obtained sparse models a score; and selecting the model that has the highest score; or
characterizing said obtained sparse models on a user interface of the digital audio workstation, and receiving user input on the user interface indicating the selected model;
and further cause:
adjusting, by the digital audio workstation, based on the selected model, timing information (tᵢ) of the rhythmic structure of the music sequence (S) to comprise an offset (oᵢ); and
outputting, by the digital audio workstation, the music sequence (S) comprising one or more adjusted times (tᵢ+oᵢ).

20. A non-transitory computer-readable medium storing instructions that, when executed by at least one processor of a digital audio workstation, cause the digital audio workstation to perform a method comprising:
obtaining, by the digital audio workstation, sparse models of human-played music for humanizing a rhythmic structure of a music sequence (S), said sparse models comprising information indicating timing (t′₁, . . . , t′ₙ) of sounds (s₁, . . . , sₙ) of a humanized music sequence (S′);
selecting, by the digital audio workstation, a model from the obtained sparse models based on at least one of the following:
generating for each of the obtained sparse models a score; and selecting the model that has the highest score; or
characterizing said obtained sparse models on a user interface of the digital audio workstation, and receiving user input on the user interface indicating the selected model;
said method further comprising:
adjusting, by the digital audio workstation, based on the selected model, timing information (tᵢ) of the rhythmic structure of the music sequence (S) to comprise an offset (oᵢ); and
outputting, by the digital audio workstation, the music sequence (S) comprising one or more adjusted times (tᵢ+oᵢ).
